(19) United States
(12) Patent Application Publication
(10) Pub. No.: US 2026/0086383 A1
(43) Pub. Date: Mar. 26, 2026

(54) OPTICAL DEVICE

(71) Applicant: GUANGZHOU LUXVISIONS INNOVATION TECHNOLOGY LIMITED, Guangzhou City (CN)

(72) Inventor: Lee Lin Tsai, Guangzhou City (CN)

(73) Assignee: GUANGZHOU LUXVISIONS INNOVATION TECHNOLOGY LIMITED, Guangzhou City (CN)

(21) Appl. No.: 19/177,654

(22) Filed: Apr. 14, 2025

Related U.S. Application Data
(60) Provisional application No. 63/699,765, filed on Sep. 26, 2024.

(30) Foreign Application Priority Data
Jan. 2, 2025 (CN) 202510005172.6

(51) Int. Cl. G02B 27/28; G02B 5/30

(52) U.S. Cl. CPC G02B 27/283; G02B 5/3016

(57) ABSTRACT

The disclosure provides an optical device, including: a light source, used to emit a beam; a polarizing beam splitting layer, located on an optical path of the beam and splitting the beam into a first beam and a second beam, wherein the first beam passes through the polarizing beam splitting layer, the second beam is reflected by the polarizing beam splitting layer, the first beam has a first polarization direction, and the second beam has a second polarization direction perpendicular to the first polarization direction; a phase retardation element, located on an optical path of the second beam, wherein the second beam passes through the phase retardation element at least once to become a third beam with the first polarization direction; a lens, located on the optical paths of the first beam and the third beam, wherein the first beam and the third beam respectively pass through the lens.

### CROSS-REFERENCE TO RELATED APPLICATION

This application claims the priority benefit of U.S. provisional application Ser. No. 63/699,765, filed on Sep. 26, 2024 and China application serial no. 202510005172.6, filed on Jan. 2, 2025. The entirety of each of the above-mentioned patent applications is hereby incorporated by reference herein and made a part of this specification.

### BACKGROUND

### Technical Field

The disclosure relates to an optical device.

### Description of Related Art

Light emitting devices, such as light emitting diodes, are widely used to various optical devices. In order for the light emitting device to emit light in a single polarization direction, a polarizer is normally used to filter the light to obtain polarized light in a specific polarization direction. However, to filter the light through the polarizer will lose a half amount of the light, causing brightness and efficiency of light are reduced. Furthermore, a beam of light usually requires an optical lens to enlarge the beam area, and will increase the size and the weight of the light emitting device.

### SUMMARY

The disclosure provides an optical device, including: a light source, used to emit a beam of light ; a polarizing beam splitting layer, located on an optical path of the beam and splitting the beam into a first beam and a second beam, wherein the first beam passes through the polarizing beam splitting layer, the second beam is reflected by the polarizing beam splitting layer, the first beam has a first polarization direction, and the second beam has a second polarization direction perpendicular to the first polarization direction; a phase retardation element, located on an optical path of the second beam, wherein the second beam passes through the phase retardation element at least once to become a third beam with the first polarization direction; a lens, located on the optical path of the first beam and the optical path of the third beam, wherein the first beam and the third beam respectively pass through the lens.

The optical device of the embodiments of the disclosure may recycle beams with different polarization directions that are filtered out by a filter, so as to improve the system brightness and increase the lighting efficiency. Moreover, the number of lenses used and the optical space may be reduced, thereby reducing the size of the light source device and the overall weight.

### BRIEF DESCRIPTION OF THE DRAWINGS

FIG. 1 is a schematic diagram of an optical device according to some embodiments of the disclosure.

FIG. 2 is a schematic diagram of an optical device according to some embodiments of the disclosure.

FIG. 3 is a schematic diagram of an optical device according to some embodiments of the disclosure.

FIG. 4 is a schematic diagram of an optical device according to some embodiments of the disclosure.

FIG. 5 is a schematic diagram of an optical device according to some embodiments of the disclosure.

FIG. 6 is a schematic diagram of an optical device according to some embodiments of the disclosure.

FIG. 7 is a schematic diagram of an optical device according to some embodiments of the disclosure.

FIG. 8A, FIG. 8B, and FIG. 8C are respectively a schematic diagram of an optical device according to an embodiment of the disclosure.

FIG. 9A, FIG. 9B, and FIG. 9C are respectively a schematic diagram of an optical device according to an embodiment of the disclosure.

### DESCRIPTION OF THE EMBODIMENTS

The following lists embodiments and describes the embodiments in detail with reference to the drawings, but the embodiments provided are not intended to limit the scope of the disclosure. In addition, the sizes of elements in the drawings are drawn for the convenience of explanation and do not represent the actual size ratios of the elements. Furthermore, although terms such as “first” and “second” are used herein to describe different elements and/or film layers, the elements and/or the film layers should not be limited to the terms. Rather, the terms are only used to distinguish one element or film layer from another element or film layer. Therefore, a first element or film layer discussed below may be referred to as a second element or film layer without departing from the teachings of the embodiments. For easier understanding, similar elements will be described below with the same numerals.

In describing the embodiments of the disclosure, different examples may use repeated reference numerals and/or terms. The repeated numerals or terms are for the purpose of simplicity and clarity, and are not used to limit the relationship between various embodiments and/or described appearance structures. Furthermore, if the following invention content of the specification describes that a first feature is formed on or above a second feature, it means that the same includes an embodiment in which the first feature and the second feature are in direct contact, and also includes an embodiment in which an additional feature is formed between the first feature and the second feature, so that the first feature and the second feature may not be in direct contact. For easier understanding, similar elements will be described below with the same numerals.

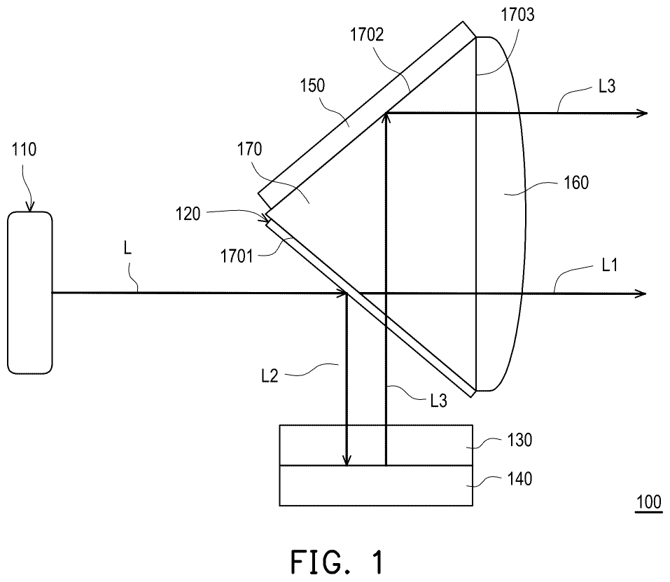

FIG. 1 is a schematic diagram of an optical device according to some embodiments of the disclosure.

Please refer to FIG. 1. An optical device 100 includes a light source 110, a polarizing beam splitting layer 120, a phase retardation element 130, and a lens 160.

The light source 110 is used to emit a beam L. The beam L emitted by the light source 110 is unpolarized light and does not have a specific polarization direction.

In some embodiments, the light source 110 is a white light LED or a monochromatic LED, or a light emitting element with similar features, but the disclosure is not limited thereto. In some embodiments, the beam L is white light or monochromatic light, wherein the monochromatic light is, for example, red light, green light, or blue light, but the disclosure is not limited thereto.

The polarizing beam splitting layer 120 is located on an optical path of the beam L and splits the beam L into a first beam L1 and a second beam L2, wherein the first beam L1 passes through the polarizing beam splitting layer 120, the second beam L2 is reflected by the polarizing beam splitting layer 120, the first beam L1 has a first polarization direction, and the second beam L2 has a second polarization direction perpendicular to the first polarization direction.

Specifically, the polarizing beam splitting layer 120 may allow the first beam L1 with the first polarization direction to pass through, and reflect the second beam L2 with the second polarization direction, so as to generate polarized light, that is, the first beam L1 with the first polarization direction.

In some embodiments, the first polarization direction is one of P polarization and S polarization, and the second polarization direction is the other one of P polarization and S polarization. Therefore, a phase difference between the first polarization direction and the second polarization direction is 90 degrees. The selection of the specific polarization direction is determined according to actual application requirements, but the disclosure is not limited thereto.

In some embodiments, the polarizing beam splitting layer 120 may be a multi-layer optical coating, a wire grid polarizer (WGP), a reflective polarizing film, or other optical elements with similar functions, but the disclosure is not limited thereto.

The phase retardation element 130 is located on an optical path of the second beam L2. The second beam L2 passes through the phase retardation element 130 at least once to become a third beam L3 with the first polarization direction.

The lens 160 is located on an optical path of the first beam L1 and an optical path of the third beam L3, wherein the first beam L1 and the third beam L3 respectively pass through the lens 160.

In the embodiment, the lens may be converging or diverging, such as a convex lens, a concave lens, or other optical elements with similar optical properties, but the disclosure is not limited thereto.

Specifically, the optical device 100 also includes a first reflection element 140 located on the optical path of the second beam L2 and a second reflection element.

The first reflection element 140 is located on the optical path of the second beam L2. In some embodiments, the first reflection element 140 is a reflector or an optical element with similar optical features, but the disclosure is not limited thereto.

The second reflection element 150 is located on the optical path of the third beam L3. In some embodiments, the second reflection element 150 is an optical film with a reflective property or an optical element with similar optical features, but the disclosure is not limited thereto.

After passing through the phase retardation element 130, the second beam L2 is reflected by the first reflection element 140 and passes through the phase retardation element 130 again, so that the second beam L2 becomes the third beam L3 with the first polarization direction.

In the embodiment, the phase retardation element 130 is a quarter-wave plate, so when the second beam L2 passes through the phase retardation element 130, the phase of the second beam L2 increases or decreases by 45 degrees.

Therefore, when the second beam L2 passes through the quarter-wave plate, is reflected by the first reflection element 140, and then passes through the quarter-wave plate again, the phase of the second beam L2 increases or decreases by 90 degrees due to passing through the quarter-wave plate twice. Therefore, the second beam L2 with the second polarization direction becomes the third beam L3 with the first polarization direction.

As shown in FIG. 1, the optical device 100 also includes a prism 170. The prism 170 is an isosceles right triangle having a first vertical surface 1701, a second vertical surface 1702, and an inclined surface 1703. The polarizing beam splitting layer 120 is located on the first vertical surface 1701 of the prism 170, the second reflection element 150 is located on the second vertical surface 1702 of the prism 170, and the lens 160 is located on the inclined surface 1703 of the prism 170.

In some embodiments, the polarizing beam splitting layer 120 may be installed on the first vertical surface 1701 by gluing, or an optical film may also be coated on the first vertical surface 1701 by coating process. The second reflection element 150 may bond a high-reflection optical film onto the second vertical surface 1702 by gluing, or an optical film may also be coated on the second vertical surface 1702 by coating process. The lens 160 may be installed on the third vertical surface 1703 by gluing.

Therefore, after the first beam L1 passes through the polarizing beam splitting layer 120, the first beam L1 passes through the prism 170 and passes through the lens 160.

On the other hand, the third beam L3 with the first polarization direction passes through the polarizing beam splitting layer 120, then passes through the prism 170, is reflected by the second reflection element 150, has the same traveling direction as the first beam L1, and then passes through the lens 160.

At this time, the first beam L1 and the third beam L3 passing through the lens 160 both have the same polarization direction, that is, the first polarization direction.

Therefore, through the optical device 100 shown in FIG. 1, the second beam L2 reflected by the polarizing beam splitting layer 120 passes through the phase retardation element 130 (that is, the quarter-wave plate) twice, so that the second beam L2 with the second polarization direction may be transformed into the third beam L3 with the first polarization direction. Therefore, the light output and the beam area may be effectively increased, and the lighting efficiency of the optical device may be improved.

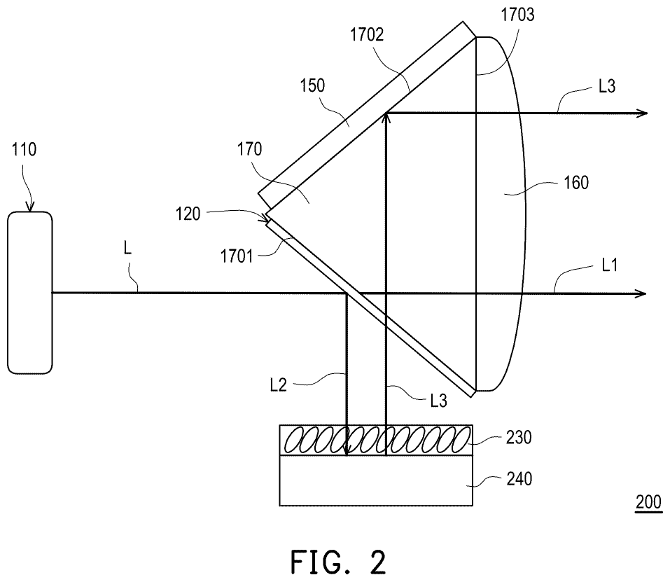

FIG. 2 is a schematic diagram of an optical device according to some embodiments of the disclosure.

Please refer to FIG. 2. An optical device 200 shown in FIG. 2 is similar to the optical device 100 shown in FIG. 1, so similarities are not described again.

The differences between the optical device 200 shown in FIG. 2 and the optical device 100 shown in FIG. 1 are that in the optical device 200, the phase retardation element 130 of the optical device 100 is changed into a phase retardation element 230, and the first reflection element 140 is changed into a first reflection element 240. Specifically, in the embodiment, the phase retardation element 230 is a liquid crystal material, and the first reflection element 240 is a substrate. The phase retardation element 230 and the first reflection element 240 form a liquid crystal on silicon (LCOS) panel. Through applying a voltage to the phase retardation element 230 (that is, the liquid crystal material), the phase retardation element 230 (that is, the liquid crystal material) may have the same effect as the quarter-wave plate and may be used to change the phase of the second beam L2.

Therefore, the second beam L2 passes through the phase retardation element 230 (that is, the liquid crystal material), is reflected by the first reflection element 240, and then passes through the phase retardation element 230 (that is, the liquid crystal material) again to become the third beam L3 with the first polarization direction, and enters the lens 160 along an optical path similar to that of FIG. 1.

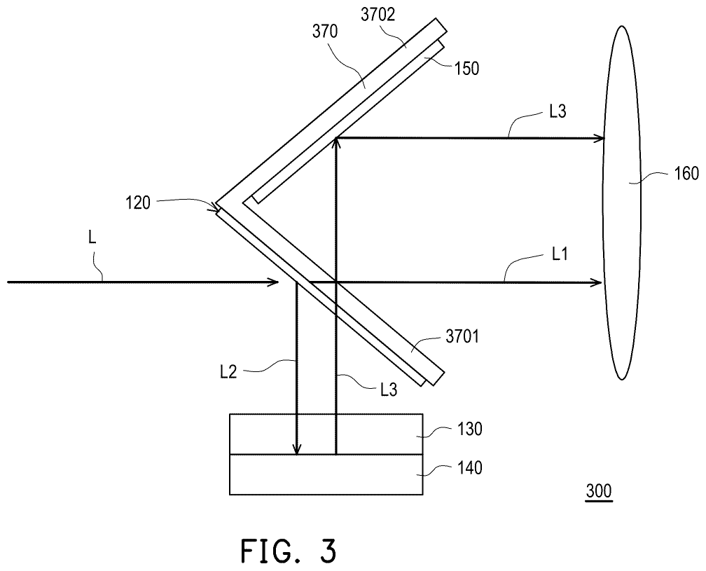

FIG. 3 is a schematic diagram of an optical device according to some embodiments of the disclosure.

Please refer to FIG. 3. An optical device 300 shown in FIG. 3 is similar to the optical device 100 shown in FIG. 1, so similarities are not described again.

The difference between the optical device 300 shown in FIG. 3 and the optical device 100 shown in FIG. 1 is that in the optical device 300, the prism 170 of the optical device 100 is changed into an L-shaped glass 370. As shown in FIG. 3, the L-shaped glass 370 includes a first surface 3701 and a second surface 3702 perpendicular to each other, wherein the polarizing beam splitting layer 120 is located on the first surface 3701, and the second reflection element 150 is located on the second surface 3702. Specifically, the polarizing beam splitting layer 120 is located on the side of the first surface 3701 facing the phase retardation element 130, and the second reflection element 150 is located on the side of the second surface 3702 facing the first surface 3701. After being reflected by the second reflection element 150, the third beam L3 has the same traveling direction as the first beam L1.

Specifically, as shown in FIG. 3, after sequentially passing through the polarizing beam splitting layer 120 and the first surface 3701 of the L-shaped glass 370, the first beam L1 passes through an air layer and then enters the lens 160.

On the other hand, as shown in FIG. 3, after leaving the phase retardation element 130, the third beam L3 sequentially passes through the polarizing beam splitting layer 120 and the first surface 3701 of the L-shaped glass 370, then passes through the air layer, is reflected by the second reflection element 150, then passes through the air layer again, and then enters the lens 160.

Since the second reflection element 150 is located on the side of the second surface 3702 facing the first surface 3701, the third beam L3 does not pass through the second surface 3702 and generate additional loss. Therefore, through using the L-shaped glass 370, the weight of the optical device 300 may be effectively reduced. In addition, since the optical paths of the first beam L1 and the third beam L3 must pass through the air layer before entering the lens 160, compared to the optical device 100 in which the optical paths of the first beam L1 and the third beam L3 must pass through the prism 170 before entering the lens 160, the loss of the first beam L1 and the third beam L3 caused by passing through the medium in the prism 170 may be reduced.

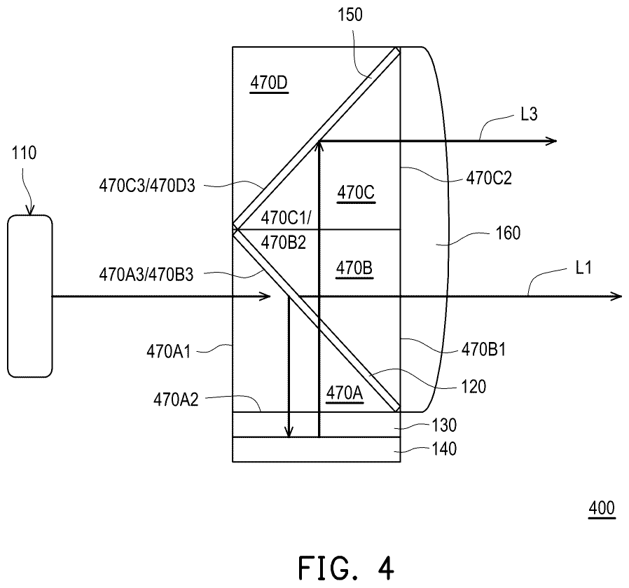

FIG. 4 is a schematic diagram of an optical device according to some embodiments of the disclosure.

Please refer to FIG. 4. An optical device 400 includes the light source 110, the polarizing beam splitting layer 120, the phase retardation element 130, the first reflection element 140, the second reflection element 150, and the lens 160. The above elements have been described in the above embodiments and will not be described again here.

The optical device 400 further includes a first prism 470A, a second prism 470B, and a third prism 470C.

A first vertical surface 470A1 of the first prism 470A is a light incident surface of the beam L, a second vertical surface 470A2 of the first prism 470A is connected to the phase retardation element 130, and an inclined surface 470A3 of the first prism 470A is connected to the polarizing beam splitting layer 120.

A first vertical surface 470B1 of the second prism 470B is connected to the lens 160, a second vertical surface 470B2 of the second prism 470B is connected to a first vertical surface 470C1 of the third prism 470C, and an inclined surface 470B3 of the second prism 470B is connected to the polarizing beam splitting layer 120.

A second vertical surface 470C2 of the third prism 470C is connected to the lens 160, and an inclined surface 470C3 of the third prism 470C is connected to the second reflection element 150.

After being reflected by the second reflection element 150, the third beam L3 has the same traveling direction as the first beam L1.

Therefore, when entering the first prism 470A from the first vertical surface 470A1 of the first prism 470A, the beam L is split into the first beam L1 with first polarization direction and the second beam L2 with the second polarization direction by the polarizing beam splitting layer 120 at the inclined surface 470A3 of the first prism 470A and the inclined surface 470B3 of the second prism 470B.

The first beam L1 passes through the second prism 470B, and enters the lens 160 from the first vertical surface 470B1 of the second prism 470B.

The second beam L2 is reflected by the polarizing beam splitting layer 120, passes through the first prism 470A, and enters the phase retardation element 130 from the second vertical surface 470A2 of the first prism 470A. After passing through the phase retardation element 130, the second beam L2 is reflected by the first reflection element 140, and passes through the phase retardation element 130 again, so that the second beam L2 becomes the third beam L3 with the first polarization direction.

The third beam L3 with the first polarization direction enters the first prism 470A from the second vertical surface 470A2 of the first prism 470A. After passing through the polarizing beam splitting layer 120, the third beam L3 sequentially passes through the second prism 470B and the third prism 470C, is reflected by the second reflection element 150, and then enters the lens 160 from the second vertical surface 470C2 of the third prism 470C.

At this time, the first beam L1 and the third beam L3 passing through the lens 160 both have the same polarization direction, that is, the first polarization direction.

In the embodiment, the first prism 470A, the second prism 470B, and the third prism 470C have the same shape, which is an isosceles right triangle.

In the embodiment, the optical device 400 further includes a fourth prism 470D. An inclined surface 470D3 of the fourth prism 470D is connected to the second reflection element 150.

In the embodiment, the fourth prism 470D has the same shape as the first prism 470A, the second prism 470B, and the third prism 470C.

Since the first prism 470A, the second prism 470B, the third prism 470C, and the fourth prism 470D all have the same shape and are isosceles right triangles, the first prism 470A and the second prism 470B may form a cube, and the third prism 470C and the fourth prism 470D may form a cube, thereby effectively fixing the relative positions of the polarizing beam splitting layer 120, the phase retardation element 130, the first reflection element 140, the second reflection element 150, and the lens 160 in the optical device 400.

In some embodiments, the light source 110 may be directly attached to the first vertical surface 470A1 of the first prism 470A, so that the optical path of the beam L does not need to pass through the air layer and directly enters the first prism 470A.

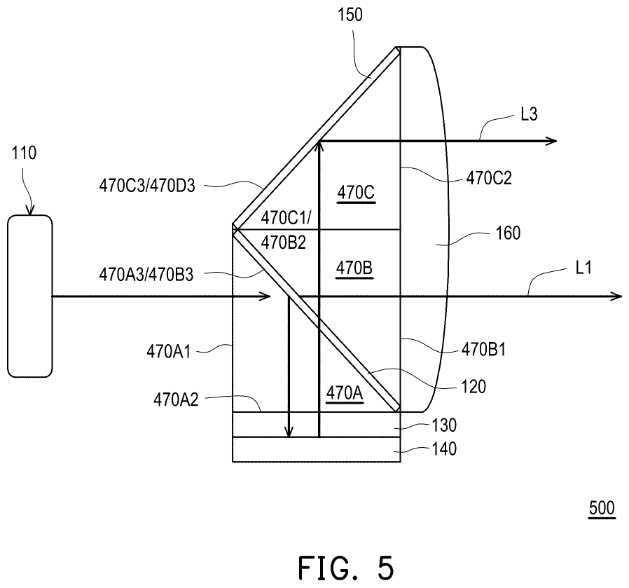

FIG. 5 is a schematic diagram of an optical device according to some embodiments of the disclosure.

Please refer to FIG. 5. An optical device 500 shown in FIG. 5 is similar to the optical device 400 shown in FIG. 4, so similarities are not described again.

The difference between the optical device 500 shown in FIG. 5 and the optical device 400 shown in FIG. 4 is that the optical device 500 does not include the fourth prism 470D. In other words, the optical device 400 has four prisms of the same shape, while the optical device 500 has three prisms of the same shape.

Since the fourth prism 470D is not on the optical path of the third beam L3, the optical device 500 has the same optical path as the optical device 400.

Since the optical device 500 has only three prisms, the weight of the optical device 500 may be effectively reduced and the available space may be increased compared to the optical device 400. However, since the third prism 470C lacks the corresponding fourth prism 470D, the protection of the second reflection element 150 may be reduced.

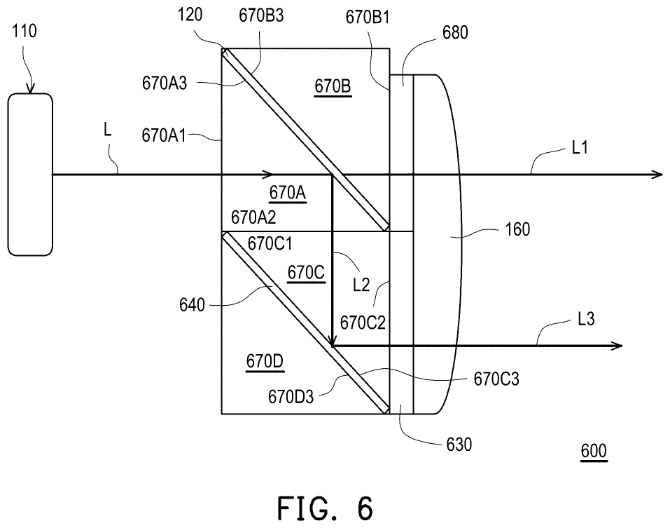

FIG. 6 is a schematic diagram of an optical device according to some embodiments of the disclosure.

Please refer to FIG. 6. An optical device 600 includes the light source 110, the polarizing beam splitting layer 120, and the lens 160. The above elements have been described in the above embodiments and will not be described again here.

The optical device 600 further includes a reflection element 640 and a phase retardation element 630.

The phase retardation element 630 is located on the optical path of the second beam L2.

The reflection element 640 is located on the optical path of the second beam L2.

After being reflected by the reflection element 640, the second beam L2 passes through the phase retardation element 630 to become the third beam L3 with the first polarization direction.

In the embodiment, the phase retardation element 630 is a half-wave plate. Therefore, when passing through the phase retardation element 630 (that is, the half-wave plate), the second beam L2 with the second polarization direction may become the third beam L3 with the first polarization direction.

Therefore, compared to the optical device 100, 200, 300, 400, or 500 shown in FIG. 1 to FIG. 5 in which the second beam L2 must pass through the phase retardation element 130 or 230 twice, the second beam L2 in the optical device 600 only needs to pass through the phase retardation element 630 once, thereby reducing the loss of the second beam L2.

In addition, compared to the optical devices 100, 200, 300, 400, and 500 shown in FIG. 1 to FIG. 5, which all have the first reflection element 140 and the second reflection element 150, the optical device 600 only needs one reflection element 640. Therefore, the manufacturing cost may be reduced.

As shown in FIG. 6, the optical device 600 further includes a first prism 670A, a second prism 670B, a third prism 670C, and a fourth prism 670D.

A first vertical surface 670A1 of the first prism 670A is a light incident surface of the beam L, a second vertical surface 670A2 of the first prism 670A is connected to a first vertical surface 670C1 of the third prism 670C, and an inclined surface 670A3 of the first prism 670A is connected to the polarizing beam splitting layer 120.

A first vertical surface 670B1 of the second prism 670B is a light emergent surface of the first beam L1, and an inclined surface 670B3 of the second prism 670B is connected to the polarizing beam splitting layer 120.

A second vertical surface 670C2 of the third prism 670C is connected to the phase retardation element 630, and an inclined surface 670C3 of the third prism 670C is connected to the reflection element 640.

An inclined surface 670D3 of the fourth prism 670D is connected to the reflection element 640.

Therefore, when entering the first prism 670A from the first vertical surface 670A1 of the first prism 670A, the beam L is split into the first beam L1 with the first polarization direction and the second beam L2 with the second polarization direction by the polarizing beam splitting layer 120 at the inclined surface 670A3 of the first prism 670A and the inclined surface 670B3 of the second prism 670B.

The first beam L1 passes through the second prism 670B, and enters the lens 160 from the first vertical surface 670B1 of the second prism 670B via an air layer 680.

The second beam L2 is reflected by the polarizing beam splitting layer 120, passes through the first lens 670A, and enters the third prism 670C from the second vertical surface 670A2 of the first prism 670A and the first vertical surface 670C1 of the third prism 670C. After being reflected by the reflection element 640, the second beam L2 passes through the third prism 670C, and enters the phase retardation element 630 from the second vertical surface 670C2 of the third prism 670C. After passing through the phase retardation element 630, the second beam L2 becomes the third beam L3 with the first polarization direction and enters the lens 160.

At this time, the first beam L1 and the third beam L3 passing through the lens 160 both have the same polarization direction, that is, the first polarization direction.

In the embodiment, the first prism 670A, the second prism 670B, the third prism 670C, and the fourth prism 670D have the same shape, which is an isosceles right triangle.

Since the first prism 670A, the second prism 670B, the third prism 670C, and the fourth prism 670D all have the same shape and are isosceles right triangles, the first prism 670A and the second prism 670B may form a cube, and the third prism 670C and the fourth prism 670D may form a cube, thereby fixing the relative positions of the polarizing beam splitting layer 120, the phase retardation element 630, and the reflection element 640 in the optical device 600 well.

Furthermore, in some embodiments, the lens 160 and the phase retardation element 630 are connected by gluing, so that the relative position of the lens 160 in the optical device 600 may be fixed.

In some embodiments, the light source 110 may be directly attached to the first vertical surface 670A1 of the first prism 670A, so that the optical path of the beam L does not need to pass through the air layer and directly enters the first prism 470A.

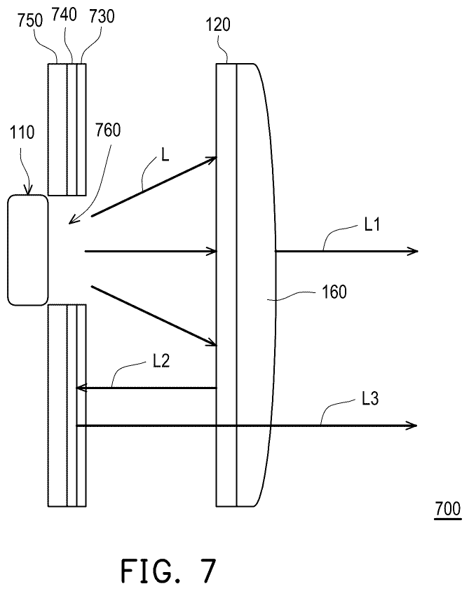

FIG. 7 is a schematic diagram of an optical device according to some embodiments of the disclosure.

Please refer to FIG. 7. An optical device 700 includes the light source 110, the polarizing beam splitting layer 120, and the lens 160. The above elements have been described in the above embodiments and will not be described again here.

The optical device 700 further includes a reflection element 740 and a phase retardation element 730.

The reflection element 740 is disposed on a substrate 750 and is located on the optical path of the second beam L2.

The phase retardation element 730 is disposed on the reflection element 740 and is located on the optical path of the second beam L2.

The phase retardation element 730 and the polarizing beam splitting layer 120 may be separated by air or glass.

In addition, the phase retardation element 730 and the reflection element 740 respectively have an opening 760, wherein the beam L enters the polarizing beam splitting layer 120 via the opening 760.

Therefore, the light source 110 emits the beam L entering the polarizing beam splitting layer 120 via the opening 760.

The polarizing beam splitting layer 120 is located on the optical path of the beam L and splits the beam L into the first beam L1 and the second beam L2, wherein the first beam L1 passes through the polarizing beam splitting layer 120, the second beam L2 is reflected by the polarizing beam splitting layer 120, the first beam L1 has the first polarization direction, and the second beam L2 has the second polarization direction perpendicular to the first polarization direction.

The first beam L1 passes through the polarizing beam splitting layer 120, and passes through the lens 160.

After being reflected by the polarizing beam splitting layer 120, the second beam L2 enters and passes through the phase retardation element 730, is reflected by the reflection element 740, and then passes through the phase retardation element 730 again to become the third beam L3 with the first polarization direction. The third beam L3 sequentially passes through the polarizing beam splitting layer 120 and the lens 160.

In the embodiment, the phase retardation element 730 is a quarter-wave plate.

In the embodiment, the material of the substrate 750 may be plastic, glass, or a printed circuit board, but the disclosure is not limited thereto. In some embodiments, the substrate 750 may also be a plastic casing shared with mechanical members.

Therefore, compared to the optical devices 100, 200, 300, 400, and 500 shown in FIG. 1 to FIG. 5, which all have the first reflection element 140 and the second reflection element 150, the optical device 700 only needs one reflection element 740. Therefore, the optical path may be shortened. At the same time, the optical device 700 may be thinner and lighter, the weight of the device may be reduced, and the manufacturing cost may be reduced.

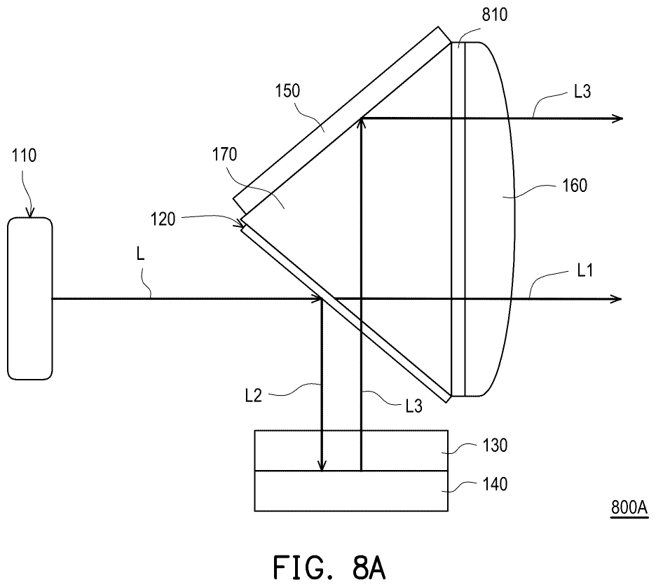

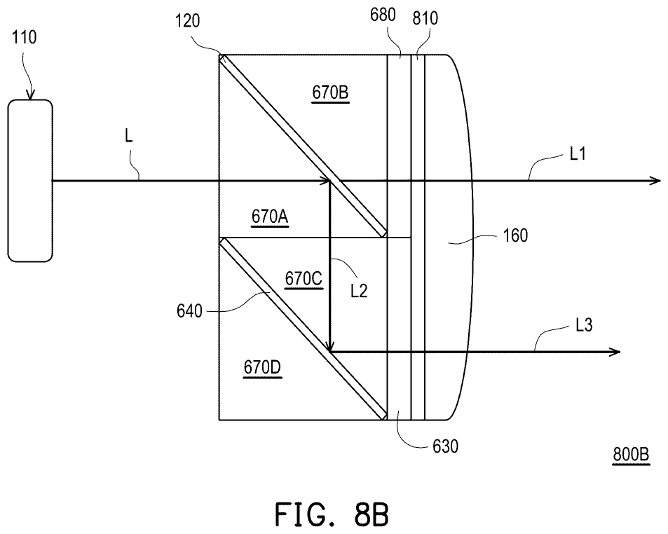

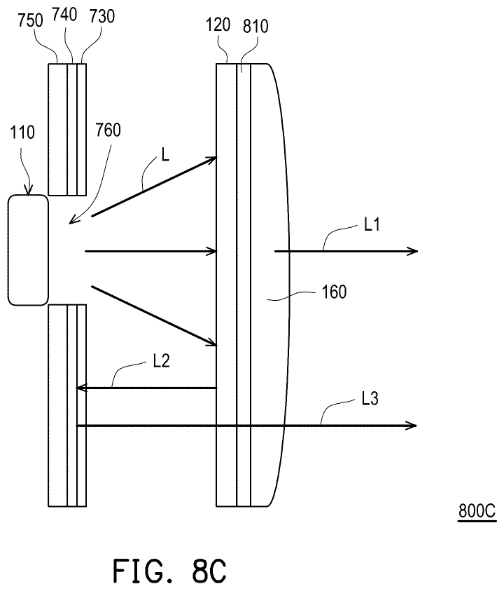

FIG. 8A, FIG. 8B, and FIG. 8C are respectively a schematic diagram of an optical device according to an embodiment of the disclosure.

Please refer to FIG. 8A. An optical device 800A shown in FIG. 8A is similar to the optical device 100 shown in FIG. 1, so similarities are not described again.

The difference between the optical device 800A shown in FIG. 8A and the optical device 100 shown in FIG. 1 is that the optical device 800A further includes a quarter-wave plate 810 located on the optical paths of the first beam L1 and the third beam L3. Specifically, as shown in FIG. 8A, the quarter-wave plate 810 is located between the polarizing beam splitting layer 120 and the lens 160.

The quarter-wave plate 810 is used to change the polarization directions of the first beam L1 and the third beam L3 from linear polarization to circular polarization or from linear polarization to elliptical polarization, so as to change the polarization directions of the first beam L1 and the third beam L3 at the same time.

Please refer to FIG. 8B. An optical device 800B shown in FIG. 8B is similar to the optical device 400 shown in FIG. 4, so similarities are not described again.

The difference between the optical device 800B shown in FIG. 8B and the optical device 400 shown in FIG. 4 is that the optical device 800B further includes the quarter-wave plate 810 disposed between the phase retardation element 630 and the lens 160.

Please refer to FIG. 8C. An optical device 800C shown in FIG. 8C is similar to the optical device 700 shown in FIG. 7, so similarities are not described again.

The difference between the optical device 800C shown in FIG. 8C and the optical device 700 shown in FIG. 7 is that the optical device 800C further includes the quarter-wave plate 810 disposed between the polarizing beam splitting layer 120 and the lens 160.

Through disposing the quarter-wave plate 810 in the optical device 800A, 800B, or 800C, the polarization directions of the first beam L1 and the third beam L3 may be changed from linear polarization to circular polarization or from linear polarization to elliptical polarization, so as to change the polarization directions of the first beam L1 and the third beam L3 at the same time.

FIG. 8A to FIG. 8C are only some embodiments. The quarter-wave plate 810 may be disposed in any optical device in FIG. 1 to FIG. 7, such as being disposed as the last optical element before the first beam L1 and the third beam L3 enter the lens 160.

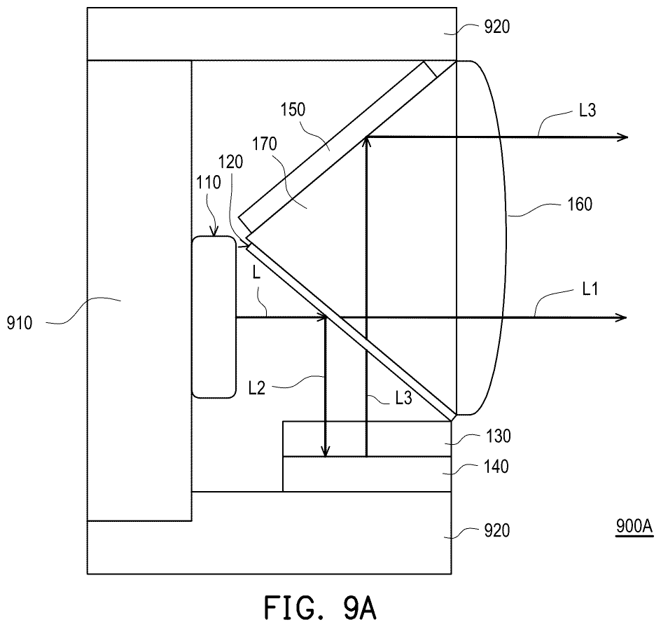

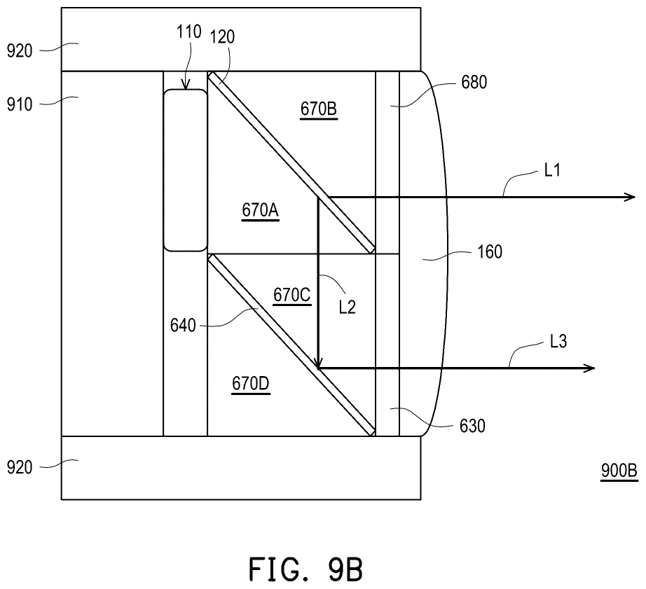

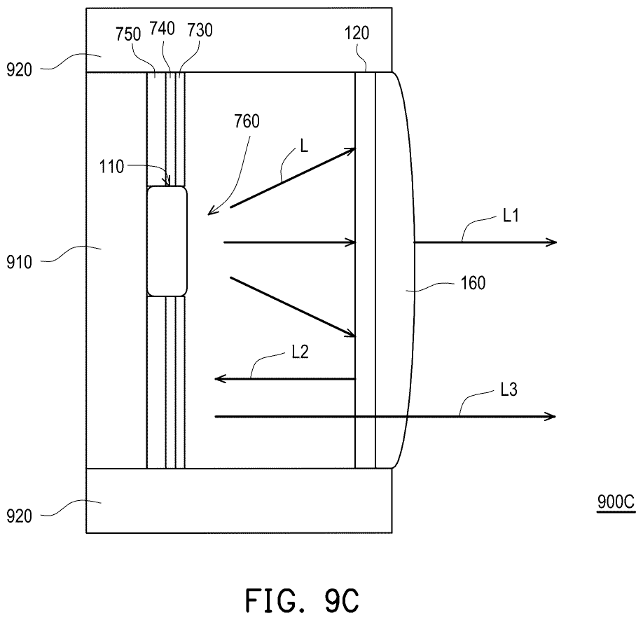

FIG. 9A, FIG. 9B, and FIG. 9C are respectively a schematic diagram of an optical device according to an embodiment of the disclosure.

Please refer to FIG. 9A. An optical device 900A shown in FIG. 9A is similar to the optical device 100 shown in FIG. 1, so similarities are not described again.

The difference between the optical device 900A shown in FIG. 9A and the optical device 100 shown in FIG. 1 is that the optical device 900A further includes a rotating stage 910 used to rotate the optical device 900A along the light emergent directions of the first beam L1 and the third beam L3. Two sides of the rotating stage 910 further include mechanical members 920 respectively connected to one side of the prism 170 and the first reflection element 140, so as to fix the optical path of the optical device 900A and stabilize the structure of the optical device 900A. In some embodiments, the material of the mechanical member 920 may be plastic, metal, or other materials with similar functions, but the disclosure is not limited thereto.

As shown in FIG. 9A, the rotating stage 910 is connected to the light source 110. When the rotating stage 910 rotates, through the assistance of the mechanical member 920, all optical elements of the optical device 900A except the rotating stage 910 may be driven to rotate together, so as to change the light emergent directions of the first beam L1 and the third beam L3, In some embodiments, the rotation angle of the rotating stage 910 may be controlled by a user or automatically controlled by a processor (not shown) according to timing requirements to generate linearly polarized light in a required polarization direction.

Please refer to FIG. 9B. An optical device 900B shown in FIG. 9B is similar to the optical device 400 shown in FIG. 4, so similarities are not described again.

The difference between the optical device 900B shown in FIG. 9B and the optical device 400 shown in FIG. 4 is that in the optical device 900B, the light source 110 is connected to the first prism 470A. In addition, the optical device 900B further includes the rotating stage 910 used to rotate the optical device 900B along the light emergent directions of the first beam L1 and the third beam L3. The two sides of the rotating stage 910 further include the mechanical members 920. One of the mechanical members 920 is connected to a side wall of the light source 110, the prism 670B, and the lens 160, and the other one of the mechanical members 920 is connected to the prism 670D, a side wall of the phase retardation element 630, and a side wall of the lens 160, so as to fix the optical path of the optical device 900B and stabilize the structure of the optical device 900B. In some embodiments, the material of the mechanical member 920 may be plastic, metal, or other materials with similar functions, but the disclosure is not limited thereto.

As shown in FIG. 9B, the rotating stage 910 is connected to the light source 110. When the rotating stage 910 rotates, through the assistance of the mechanical member 920, all optical elements of the optical device 900B except the rotating stage 910 may be driven to rotate together, so as to change the light emergent directions of the first beam L1 and the third beam L3.

Please refer to FIG. 9C. An optical device 900C shown in FIG. 9C is similar to the optical device 700 shown in FIG. 7, so similarities are not described again.

The difference between the optical device 900C shown in FIG. 9C and the optical device 700 shown in FIG. 7 is that the optical device 900C further includes the rotating stage 910 used to rotate the optical device 900C along the light emergent directions of the first beam L1 and the third beam L3. Two sides of the rotating stage 910 also include the mechanical members 920. The mechanical member 920 is connected to a side wall of the polarizing beam splitting layer 120, a side wall of the phase retardation element 730, a side wall of the reflection element 740, a side wall of the substrate 750, and the lens 160, so as to fix the optical path of the optical device 900C and stabilize the structure of the optical device 900C. In some embodiments, the material of the mechanical member 920 may be plastic, metal, or other materials with similar functions, but the disclosure is not limited thereto.

As shown in FIG. 9C, the rotating stage 910 is connected to the light source 110. When the rotating stage 910 rotates, through the assistance of the mechanical member 920, all optical elements of the optical device 900C except the rotating stage 910 may be driven to rotate together, so as to change the light emergent directions of the first beam L1 and the third beam L3.

FIG. 9A to FIG. 9C are only some embodiments. The rotating stage 910 may be disposed in any optical device in FIG. 1 to FIG. 7. For example, the rotating stage 910 is configured to be connected to the light source 110. When the rotating stage 910 rotates, all optical elements of the optical device except the rotating stage 910 may be driven to rotate together, so as to change the light emergent directions of the first beam L1 and the third beam L3.

In addition, the rotation angle of the rotating stage 910 may be controlled by the user or automatically controlled by the processor (not shown) according to timing requirements to generate linearly polarized light in a required polarization direction.

In summary, the optical device of the disclosure may recycle beams with different polarization directions that are filtered out by a filter, so as to improve the system brightness and increase the lighting efficiency.

What is claimed is:

1. An optical device, comprising:
a light source, used to emit a beam;
a polarizing beam splitting layer, located on an optical path of the beam and splitting the beam into a first beam and a second beam, wherein the first beam passes through the polarizing beam splitting layer, the second beam is reflected by the polarizing beam splitting layer, the first beam has a first polarization direction, and the second beam has a second polarization direction perpendicular to the first polarization direction;
a phase retardation element, located on an optical path of the second beam, wherein the second beam passes through the phase retardation element at least once to become a third beam with the first polarization direction;
a lens, located on an optical path of the first beam and an optical path of the third beam, wherein the first beam and the third beam respectively pass through the lens.

2. The optical device according to claim 1, wherein the light source is a white light LED or a monochromatic LED.

3. The optical device according to claim 1, wherein the beam is white light or monochromatic light.

4. The optical device according to claim 1, wherein the first polarization direction is one of P polarization and S polarization, and the second polarization direction is other one of P polarization and S polarization.

5. The optical device according to claim 1, further comprising:
a first reflection element, located on the optical path of the second beam,
a second reflection element, located on the optical path of the third beam,
wherein after passing through the phase retardation element, the second beam is reflected by the first reflection element, and passes through the phase retardation element again, so that the second beam becomes the third beam with the first polarization direction,
wherein the third beam is reflected by the second reflection element, and then passes through the lens.

6. The optical device according to claim 5, wherein the phase retardation element is a quarter-wave plate, wherein the second beam passes through the quarter-wave plate, is reflected by the first reflection element, and then passes through the quarter-wave plate again to become the third beam with the first polarization direction.

7. The optical device according to claim 5, wherein the phase retardation element is a liquid crystal material, wherein the second beam passes through the liquid crystal material, is reflected by the first reflection element, and then passes through the liquid crystal material again to become the third beam with the first polarization direction.

8. The optical device according to claim 5, wherein the optical device further comprises a prism,
wherein the polarizing beam splitting layer is located on a first vertical surface of the prism, the second reflection element is located on a second vertical surface of the prism, and the lens is located on an inclined surface of the prism,
wherein after being reflected by the second reflection element, the third beam has a same traveling direction as the first beam.

9. The optical device according to claim 5, wherein the optical device further comprises an L-shaped glass, wherein the L-shaped glass comprises a first surface and a second surface perpendicular to each other, wherein the polarizing beam splitting layer is located on the first surface, and the second reflection element is located on the second surface,
wherein after being reflected by the second reflection element, the third beam has a same traveling direction as the first beam.

10. The optical device according to claim 5, wherein the optical device further comprises a first prism, a second prism, and a third prism,
wherein a first vertical surface of the first prism is a light incident surface of the beam, a second vertical surface of the first prism is connected to the phase retardation element, and an inclined surface of the first prism is connected to the polarizing beam splitting layer,
wherein a first vertical surface of the second prism is connected to the lens, a second vertical surface of the second prism is connected to a first vertical surface of the third prism, and an inclined surface of the second prism is connected to the polarizing beam splitting layer,
wherein a second vertical surface of the third prism is connected to the lens, and an inclined surface of the third prism is connected to the second reflection element,
wherein after being reflected by the second reflection element, the third beam has a same traveling direction as the first beam.

11. The optical device according to claim 10, wherein the first prism, the second prism, and the third prism have a same shape.

12. The optical device according to claim 10, wherein the optical device further comprises a fourth prism,
wherein an inclined surface of the fourth prism is connected to the second reflection element.

13. The optical device according to claim 12, wherein the fourth prism has a same shape as the first prism, the second prism, and the third prism.

14. The optical device according to claim 1, further comprising:
a reflection element, located on the optical path of the second beam;
a phase retardation element, located on the optical path of the second beam, wherein after being reflected by the reflection element, the second beam passes through the phase retardation element to become the third beam with the first polarization direction.

15. The optical device according to claim 14, wherein the phase retardation element is a half-wave plate.

16. The optical device according to claim 14, further comprising a first prism, a second prism, a third prism, and a fourth prism,
wherein a first vertical surface of the first prism is a light incident surface of the beam, a second vertical surface of the first prism is connected to a first vertical surface of the third prism, and an inclined surface of the first prism is connected to the polarizing beam splitting layer,
wherein a first vertical surface of the second prism is a light emergent surface of the first beam, and an inclined surface of the second prism is connected to the polarizing beam splitting layer,
wherein a second vertical surface of the third prism is connected to the phase retardation element, and an inclined surface of the third prism is connected to the reflection element,
wherein an inclined surface of the fourth prism is connected to the reflection element.

17. The optical device according to claim 16, wherein the first prism, the second prism, the third prism, and the fourth prism have a same shape.

18. The optical device according to claim 1, further comprising:
a reflection element, located on the optical path of the second beam;
a phase retardation element, located on the optical path of the second beam,
wherein the second beam passes through the phase retardation element, is reflected by the reflection element, and then passes through the phase retardation element again to become the third beam with the first polarization direction,
wherein the third beam sequentially passes through the polarizing beam splitting layer and the lens.

19. The optical device according to claim 18, wherein the phase retardation element and the reflection element respectively have an opening, wherein the beam enters the polarizing beam splitting layer via the opening.

20. The optical device according to claim 18, wherein the phase retardation element is a quarter-wave plate.

21. The optical device according to claim 1, wherein the optical device further comprises a quarter-wave plate located on the optical paths of the first beam and the third beam, and used to change polarization directions of the first beam and the third beam from linear polarization to circular polarization or from linear polarization to elliptical polarization.

22. The optical device according to claim 1, further comprising a rotating stage used to rotate the optical device along light emergent directions of the first beam and the third beam.
